(19) United States
(12) Patent Application Publication
(10) Pub. No.: US 2021/0291664 A1
(43) Pub. Date: Sep. 23, 2021

(54) METHOD FOR CONTROLLING AN ELECTRONICALLY SLIP-CONTROLLABLE POWER BRAKING SYSTEM OF A MOTOR VEHICLE, ELECTRONICALLY SLIP-CONTROLLABLE POWER BRAKING SYSTEM, AND ELECTRONIC CONTROL UNIT

(71) Applicant: Robert Bosch GmbH, Sturrgart (DE)

(72) Inventors: Markus Lang, Bad Boll (DE); Christian Woerz, Beilstein (DE)

(21) Appl. No.: 17/152,357

(22) Filed: Jan. 19, 2021

(30) Foreign Application Priority Data
Mar. 20, 2020 (DE) 102020203581.4

(51) Int. Cl. B60L 7/18; B60L 3/10; B60T 13/74

(52) U.S. Cl. CPC B60L 7/18; B60L 3/10; B60T 2270/60; B60L 2240/423; B60L 2240/465; B60T 13/745

(57) ABSTRACT

A method for controlling an electronically slip-controllable power braking system, an electronically slip-controllable power braking system, and an electronic control unit of an electronically slip-controllable power braking system. The power braking system has a friction braking device, a generator braking device, and an electronic control unit for controlling the braking devices adapted to need. The friction braking device includes an electronically activatable brake pressure generator including a displacer which is actuatable by an activatable drive unit and conveys pressure medium to a wheel brake of the power braking system. After a change of the power braking system from generating a generator braking torque to generating a friction braking torque, the activation of the drive unit of the displacer is carried out by the electronic control unit in such a way that a velocity of the actuated displacer changes strictly monotonously.

### CROSS REFERENCE

The present application claims the benefit under 35 U.S.C. § 119 of German Patent Application No. DE 102020203581.4 filed on Mar. 20, 2020, which is expressly incorporated herein by reference in its entirety.

### FIELD

The present invention relates to a method for controlling an electronically slip-controllable power braking system of a motor vehicle, an electronically slip-controllable power braking system, and an electronic control unit.

### BACKGROUND INFORMATION

Electronically slip-controllable power braking systems in motor vehicles are part of the related art. They are capable of carrying out braking processes independently of a braking intention of the driver and prevent locking wheels during driving operation, during starting, or during a braking process. Such power braking systems therefore contribute significantly to avoiding hazardous driving situations and ultimately to increasing the traffic safety.

An electronically slip-controllable power braking system is described, for example, in German Patent Application No. DE 10 2013 205 653 A1.

FIG. 1 of the present application shows, in very simplified schematic form, the power braking system in a refinement. According to this refinement, power braking system 10 has a generator braking device 14 in addition to a conventional friction braking device 12. Both braking devices may each individually or jointly provide a required total braking torque for braking a motor vehicle equipped with this power braking system 10 and thus contribute to particularly energy efficient operation of such a motor vehicle. An electronic control unit 16 controls the brake pressure and the braking torques adapted to the need.

The power braking system according to FIG. 1 is additionally equipped with a device 18 for detecting a braking need. This is a brake master cylinder 22 actuatable by the driver via a brake pedal 20. The braking need is determined by measuring an actuating travel of brake pedal 20 with the aid of a position sensor 24 and checked for plausibility using a brake pressure resulting in brake master cylinder 22. A pressure sensor 26 is provided for measuring the brake pressure.

Friction braking device 12 of this power braking system 10 is equipped with a brake pressure generator 30, which includes a displacer 32, by way of example in the form of a piston. The piston is accommodated axially movably in the interior of a cylinder 34 and delimits a pressure medium chamber 36 together with cylinder 34. To convey pressure medium to a wheel brake 38 of power braking system 10, this piston is driven by an electronically activatable drive unit 40 to perform a linear movement, as a result of which the volume of pressure medium chamber 36 successively decreases. If the pressure medium is extensively displaced or consumed from pressure medium chamber 36, the piston is driven in the opposite movement direction to fill pressure medium chamber 36 with new pressure medium.

Additional generator braking device 14 of power braking system 10 is preferably formed by an electric drive motor of the motor vehicle. During braking, it may be operated as a generator and supplies, for example, a power store of the vehicle with electric energy. The energy for driving the generator is obtained from the movement energy of the rolling vehicle.

However, the generator braking torque generated is dependent on the drive speed of the generator and decreases with decreasing drive speed. If the vehicle velocity and thus the drive speed of the generator is excessively low, sufficient generator braking torque is not available to be able to decelerate the vehicle to a standstill. Corresponding motor vehicles are therefore ultimately decelerated to a standstill solely with the aid of the friction braking device.

The control of a transition or a change of power braking system 10 from the generator braking operation into the friction braking operation by electronic control unit 16 has a large influence on the resulting driving comfort or on the noises and vibrations perceptible by the driver and/or the vehicle occupants.

### SUMMARY

The present invention may have the advantage that the occupants of the vehicle perceive preferably little feedback or none at all when the braking system changes from the generator braking operation to the friction braking operation. The latter is achieved according to the present invention by an electrical activation optimized in this regard of drive unit 40 of brake pressure generator 30 by electronic control unit 16 of power braking system 10.

It is provided that after a change of power braking system 10 from generator braking operation to friction braking operation, drive unit 40 of displacer 32 is activated by electronic control unit 16 in such a way that a velocity at which displacer 32 or the piston moves during the actuation changes strictly monotonously.

The provided method is applicable in all operating cases in which sufficient generator braking torque is no longer available and a braking intention of the driver is to be implemented by friction braking device 12.

In conventional power braking systems 10, displacer 32 or piston of brake pressure generator 30 is accelerated from a standstill to a maximum value for the velocity and thereafter further driven at constant velocity. A linear brake pressure buildup is effectuated using this operating mode, but high accelerations occur at the beginning and at the end of the actuation of displacer 32. These mechanically stress displacer 32 and its drive, and cause noises or vibrations which may be perceived as annoying by the vehicle occupants.

A smoother beginning and a smoother end of the actuation are achieved by the provided optimization of the activation. Occurring accelerations of the displacer are thus reduced, the change of the brake pressure is reduced, and finally the driving comfort is enhanced for the vehicle occupants by avoidance of perceptible noises and vibrations.

Further advantages or advantageous refinements of the present invention are described herein.

In one advantageous refinement of the present invention, it is provided that a velocity of displacer 32 from a beginning of its actuation to a maximum velocity increases strictly monotonously, and this velocity decreases strictly monotonously from the maximum velocity to an end of the actuation.

In other words, the activation of drive unit 40 by electronic control unit 16 is carried out in such a way that the velocity of displacer 32 has an arc-shaped or parabolic curve plotted over time between a beginning and an end of its actuation. The acceleration or deceleration of displacer 32 accordingly takes place continuously and without interruption and the velocity of displacer 32 accordingly changes continuously and not suddenly.

The present invention prevents a brake pressure buildup from taking place in an annoyingly perceptible manner, even in the case of high pressure buildup dynamics. In addition, pressure oscillations are avoided, which result in deceleration variations of the vehicle in spite of an existing constant braking intention.

### BRIEF DESCRIPTION OF THE DRAWINGS

The present invention is illustrated with reference to the Figures and explained in greater detail hereinafter.

FIG. 1 shows, schematically heavily simplified, the version of a power braking system explained above and refined by the integration of an additional generator braking device.

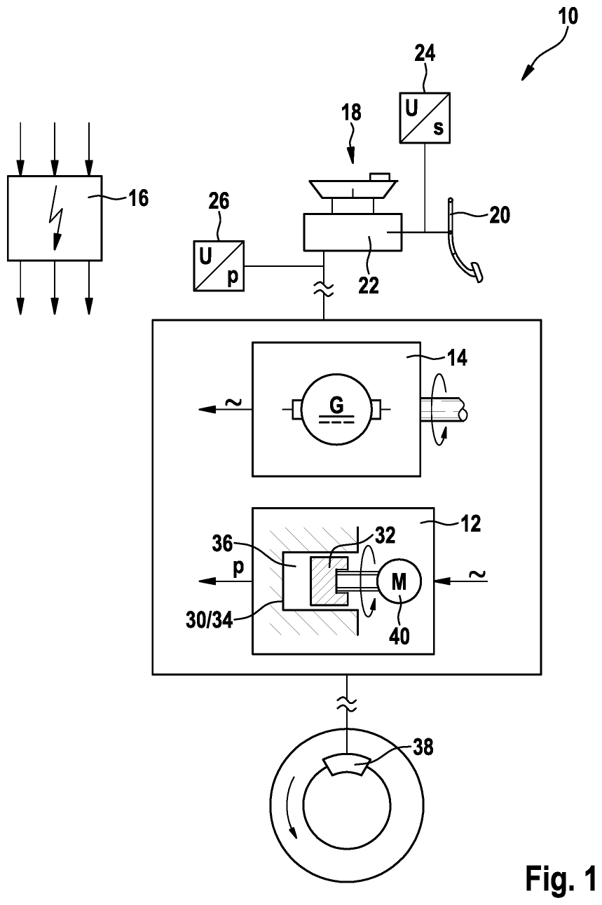

FIGS. 2 through 5 show, on the basis of diagrams, the travel, the velocity, and the acceleration of the displacer of a brake pressure generator of the friction braking device and the pulses originating from the movement of this displacer over the time of a braking process and after a change of the power braking system from the generator braking operation into the friction braking operation has taken place. The diagrams are each recorded synchronized in time with one another.

Two characteristic curves are depicted in each diagram, of which one characteristic curve illustrates the curve in the event of an activation of the piston drive according to the related art and the particular other characteristic curve illustrates, in direct comparison thereto, the curve of the particular variable in the case of an activation method according to the present invention.

### DETAILED DESCRIPTION OF EXAMPLE EMBODIMENTS

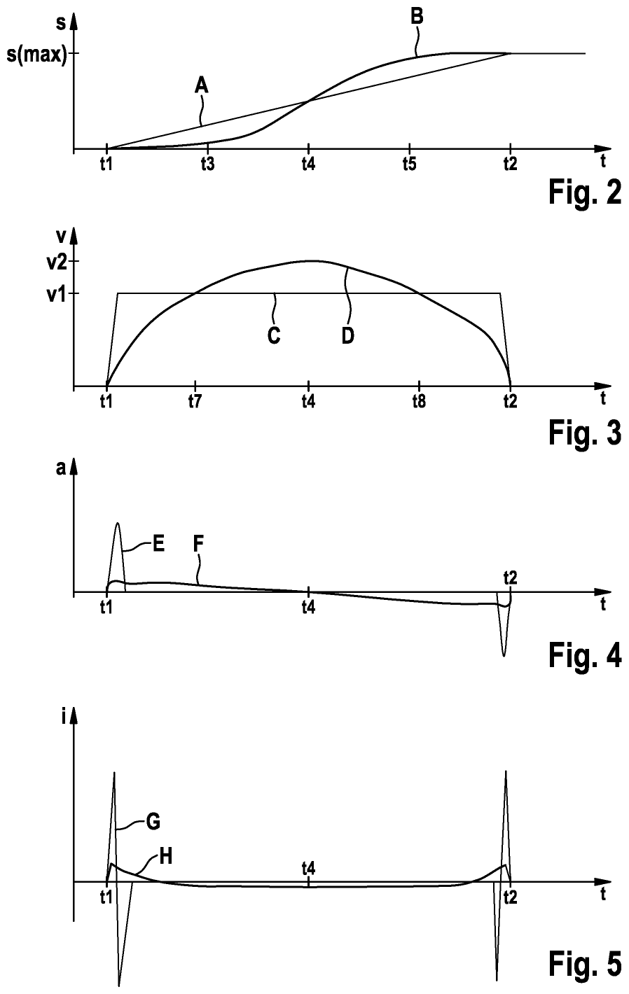

The diagram shown in FIG. 2 indicates the curve of travel s covered by displacer 32 or piston of brake pressure generator 30 over time t of a braking process taking place, after a change has taken place of power braking system 10 from generator braking operation to friction braking operation. Two characteristic curves A, B are shown, of which characteristic curve A continuously rises from a starting point t1, at which covered travel s is zero, at constant slope up to an end point t2, at which maximum travel s(max) has been covered. This characteristic curve corresponds to the activation method known from the related art for drive unit 40 of brake pressure generator 30. In this activation method, displacer 32 moves between the endpoints at constant velocity (see FIG. 3).

In contrast thereto, characteristic curve B shows an s-shaped curve between endpoints t1 and t2. Characteristic curve B indicates the movement of displacer 32 which results when brake pressure generator 30 is activated according to the method according to the present invention. Displacer 32 also begins its travel at starting point in time t1, but this travel initially only increases extremely slowly thereafter and remains significantly behind in relation to the travel according to characteristic curve A within the first half-wave of the s-shaped curve. Up to a point in time t3, the travel difference increases up to a maximum and only gradually decreases again in a range between point in time t3 and a point in time t4. At point in time t4, the piston, independently of the activation method, has covered the same travel, so that the two characteristic curves A, B intersect. Displacer 32 driven according to the method according to the present invention only thereafter covers more travel than according to the known method. The covered additional travel increases up to a point in time t5 and then gradually decreases. At point in time t2, the end of the movement is reached or travel s(max) has been covered by displacer 32.

FIG. 3 also shows, on the basis of two characteristic curves C and D, the curve of velocity v of displacer 32 moving between the two endpoints according to FIG. 2.

In the activation method according to the related art (characteristic curve C), velocity v increases at point in time t1 nearly vertically or without delay up to maximum velocity v1 and then remains constant until shortly before reaching point in time t2. At point in time t2, velocity v of displacer 32 also decreases nearly without delay to zero. A nearly rectangular velocity curve accordingly results.

The velocity curve in the case of activation according to the present invention of displacer 32 (characteristic curve D) is arc-shaped in contrast and increases strictly monotonously up to a maximum velocity v2 at point in time t4 and then decreases falling strictly monotonously to zero. Up to a point in time t7 and from a point in time t8, velocity v is lower than in the case of the related art; it is higher in between.

FIG. 4 shows characteristic curves E and F, which depict the curve of acceleration a occurring at displacer 32.

In the activation method according to the related art (characteristic curve E), a relatively pointed acceleration peak directed in the positive in the diagram occurs at the beginning and a pointed deceleration peak directed in the negative occurs at the end of the movement of displacer 32. The acceleration is zero between these peaks, since displacer 32 moves at constant velocity here (see FIG. 3).

In contrast, the acceleration in the activation method according to the present invention has the curve of an extremely flat wave (characteristic curve F). Wave peaks, i.e., maximum acceleration values, occur shortly after the beginning of the movement of displacer 32, i.e., in the area around point in time t1. Wave valleys, i.e., ranges of maximum decelerations of displacer 32, result at the end of the movement of displacer 32 (area around point in time t2). It may be inferred from the amplitude and the shape of the wave peaks and valleys that the occurring accelerations and decelerations are significantly less than those according to the known activation method (characteristic curve E). Moreover, the wavy curve shows that the acceleration in the present invention, in contrast to the related art, changes more continuously or uniformly than in the related art and does not display “jump behavior,”, i.e., no pronounced peaks.

Characteristic curves G and H of FIG. 5 illustrate the force pulses emitted by actuated displacer 32 on the hydraulic circuit of power braking system 10. Pulses having a relatively high amplitude in both directions, i.e., in the acceleration direction and also in the deceleration direction of displacer 32, each occur in the related art at the beginning (around point in time t1) and at the end of the movement of displacer 32 (around point in time t2). Peaks in the current signal for drive unit 40 and thus peaks in the drive force given to displacer 32 of brake pressure generator 30 correlate with these pulses. The latter peaks are the cause of the noises and vibrations occurring in the related art.

In the activation method according to the present invention (characteristic curve H), force pulses only occur in the acceleration direction of displacer 32. These resulting force pulses are significantly less in direct comparison in their amplitude than in the related art and moreover dissipate (around point in time t1) or build up (around point in time t2) over a longer period of time. Characteristic curve H is overall distinguished by a smooth, continuous curve. The drive force given to displacer 32 of brake pressure generator 30 by drive unit 40 behaves accordingly and as a result the drive of brake pressure generator 30 thus causes less noise and vibrations.

The provided activation method may always be used, as already described at the outset, when power braking system 10 of the vehicle is transferred or switched from a generator mode into a friction braking operation, i.e., in spite of an existing braking intention, a sufficiently high generator braking torque for decelerating the vehicle is no longer present.

In addition, it is to be noted that the present invention has only been described by way of example on the basis of a brake pressure generator 30 which is equipped with a piston/cylinder unit for pressure medium conveyance. Alternatively, it would be conceivable to use a displacer pump, for example, instead of such a brake pressure generator, for example a gearwheel pump which continuously conveys the pressure medium.

Further changes or additions to the statements in the description are possible without departing from the explained basic concept of the present invention.

What is claimed is:

1. A method for controlling an electronically slip-controllable power braking system of a motor vehicle, the power braking system being equipped with a friction braking device configured to generate a friction braking torque, a generator braking device configured to generate a generator braking torque, and an electronic control unit configured to control the friction braking device and the generator braking device in a manner adapted to need, the friction braking device including a brake pressure generator, using which a pressure medium may be conveyed to a wheel brake of the power braking system, and the brake pressure generator including a displacer actuatable by an electronically activatable drive unit for the pressure medium conveyance, the method comprising the following steps:
after a change of the power braking system from generating a generator braking torque to generating a friction braking torque, activating the drive unit of the displacer by the electronic control unit in such a way that a velocity of the actuated displacer changes strictly monotonously.

2. The method as recited in claim 1, wherein the activation of the drive unit is carried out by the electronic control unit in such a way that the velocity of the displacer increases strictly monotonously from a beginning of the actuation up to a maximum velocity of the displacer, and the velocity of the displacer decreases strictly monotonously from the maximum velocity until an end of the actuation.

3. An electronically slip-controllable power braking system for a motor vehicle, comprising:
a friction braking device configured to generate a friction braking torque;
a generator braking device configured to generate a generator braking torque; and
an electronic control unit configured to control the friction braking device and the generator braking device in a manner adapted to need;
wherein the friction braking device including a brake pressure generator, using which a pressure medium may be conveyed to a wheel brake of the power braking system;
wherein the brake pressure generator includes a displacer actuatable by an electronically activatable drive unit for the pressure medium conveyance; and
wherein the electronic control unit is configured to:
after a change of the power braking system from generating a generator braking torque to generating a friction braking torque, activate the drive unit of the displacer by the electronic control unit in such a way that a velocity of the actuated displacer changes strictly monotonously.

4. The electronically slip-controllable power braking system as recited in claim 3, wherein the displacer is a piston movably accommodated in a cylinder, which is actuatable by the drive unit to carry out a translation movement for the pressure medium conveyance.

5. An electronic control unit for controlling an electronically slip-controllable power braking system of a motor vehicle, the power braking system being equipped with a friction braking device configured to generate a friction braking torque, a generator braking device configured to generate a generator braking torque, the friction braking device including a brake pressure generator, using which a pressure medium may be conveyed to a wheel brake of the power braking system, and the brake pressure generator including a displacer actuatable by an electronically activatable drive unit for the pressure medium conveyance, the electronic control unit configured to:
after a change of the power braking system from generating a generator braking torque to generating a friction braking torque, activate the drive unit of the displacer by the electronic control unit in such a way that a velocity of the actuated displacer changes strictly monotonously.
